(19) United States
(12) Patent Application Publication
(10) Pub. No.: US 2018/0195497 A1
(43) Pub. Date: Jul. 12, 2018

(54) HANDLING DEVICE FOR A WIND TURBINE ROTOR BLADE HAVING A MOLDABLE SUPPORT PAD

(71) Applicant: General Electric Company, Schenectady, NY (US)

(72) Inventor: Ulrich Werner Neumann, Simpsonville, SC (US)

(21) Appl. No.: 15/607,778

(22) Filed: May 30, 2017

(51) Int. Cl. F03D 13/10; F03D 1/06; B66C 1/10; B65B 55/20; B65D 61/00

(52) U.S. Cl. CPC F03D 13/10; F03D 1/0675; F05B 2230/61; B65B 55/20; B65D 61/00; B66C 1/108

(57) ABSTRACT

A handling device for a rotor blade of a wind turbine e.g. that can be used for lifting, lowering, transporting, or storing the rotor blade includes at least one cradle for supporting the rotor blade and a moldable support pad secured to the cradle. The moldable support pad includes an outer covering filled with a plurality of granules that act as a fluid when the rotor blade is placed atop the support pad such that a shape of the support pad substantially matches a profile of at least one of the exterior surfaces of the rotor blade.

### FIELD

The present disclosure relates in general to wind turbines, and more particularly to handling devices for wind turbine rotor blades with moldable support pads.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The typical construction of a wind turbine involves erecting the tower and then connecting various other components to the erected tower. For example, the rotor blades may be lifted to an appropriate height and connected to the tower after erection of the tower. In some cases, each of the rotor blades is connected to a hub before lifting, and the connected rotor blades and hub are then lifted and connected to the tower as a unit. Trends towards taller towers and larger rotor diameters, however, can limit and/or preclude lifting such units to the tower due to size and/or cost. More specifically, as the rotor diameter and/or mass and hub height increases, there are few (if any) cranes that can lift such structures. Further, the sail area can become so large, that the available wind window to conduct such lifts approaches zero, i.e. the cranes cannot lift the rotor without tipping over.

Thus, current systems and methods for lifting the rotor blades involve the use of a cradle, sling, or clamping-type blade lifting tool that is lifted to the tower using a crane. More specifically, such lifting tools generally include a root cradle and a tip cradles for supporting the blade root and tip, respectively, during lifting of the rotor blade. Further, the root and tip cradles each generally include a support pad for supporting the blade root and tip, respectively, during lifting of the rotor blade. Once lifted, the rotor blade can then be connected to the hub mounted atop the tower.

The support pads of the root and tip cradles are typically shaped to match the aerodynamic profile of the rotor blade. As such, the support pads have to be customized for each rotor blade. Such customization can be time-consuming and expensive. Similar tools may also be used during further handling (such as storage and/or transportation) of the rotor blades. These tools may also have support pads that must be customized to the contour of the rotor blade where the pad will sit.

In view of the aforementioned, a handling device for wind turbine rotor blades having is desired in the art. For example, a handling device for wind turbine rotor blades having moldable support pads would be advantageous.

### BRIEF DESCRIPTION

Aspects and advantages of the invention will be set forth in part in the following description, or may be obvious from the description, or may be learned through practice of the invention.

In one aspect, the present disclosure is directed to a handling device for a rotor blade of a wind turbine e.g. that can be used for lifting, lowering, transporting, or storing the rotor blade. The handling device includes at least one cradle for supporting the rotor blade and a moldable support pad secured to the cradle. The moldable support pad includes an outer covering filled with a plurality of granules that act as a fluid when the rotor blade is placed atop the support pad such that a shape of the support pad substantially matches a profile of at least one of the exterior surfaces of the rotor blade.

In one embodiment, the plurality of granules may be made of a foam material, organic matter, a polymeric material, or any other suitable material or combinations thereof. In another embodiment, each of the plurality of granules may have one or more cross-sectional shapes, including but not limited to a circle, an oval, a triangle, a square, a rectangle, or similar. In several embodiments, the plurality of granules may have varying sizes. Alternatively, the plurality of granules may have equal sizes. In addition, each of the plurality of granules may have a diameter of less than about five (5) millimeters (mm). In further embodiments, the diameter of the granules may be more than or less than 5 mm.

In several embodiments, the outer covering may be constructed of one an elastomeric material, a fabric material, a polymer material, or similar, or combinations thereof.

In further embodiments, the handling device may further include a vacuum system configured to remove air from within the outer covering after the rotor blade is placed atop the support pad. In such embodiments, removal of the air from within the outer covering causes the moldable support pad to transform to a semi-solid or solid state that substantially matches the profile of at least one of the exterior surfaces of the rotor blade.

In additional embodiments, the handling device may also include a root cradle for supporting the root of the rotor blade, a tip cradle for supporting the tip of the rotor blade, and a structural frame body for connecting and supporting the root cradle and the tip cradle. In such an embodiment, the root and tip cradles may include a first moldable support pad and a second moldable support pad secured thereto, respectively.

In another aspect, the present disclosure is directed to a handling device for a rotor blade of a wind turbine. The handling device includes at least one cradle for supporting the rotor blade and a moldable support pad secured to the cradle. Further, the moldable support pad may include an outer covering filled with a changeable fluid. Thus, the changeable fluid is configured to change from a fluid state to a semi-solid or solid state upon applying an outside force once the rotor blade is placed thereon.

For example, in one embodiment, the changeable fluid may include a magnetorheological fluid and the outside force may be a magnetic field device for generating and passing a magnetic field through the magnetorheological fluid so as to change the changeable fluid to the semi-solid or solid state. It should be understood that the handling device may further include any of the additional features or combinations thereof as described herein.

In yet another aspect, the present disclosure is directed to a method for handling a rotor blade during lifting or lowering of the rotor blade to and from a hub mounted atop a tower of a wind turbine. The method includes placing the rotor blade atop a moldable support pad secured to a cradle of a handling device. The moldable support pad includes an outer covering filled with at least one of a plurality of granules that act as a fluid when the rotor blade is placed atop the support pad or a changeable fluid that can change between a fluid state and a semi-solid state or a solid state upon applying an outside force. Further, the method includes molding the support pad until a shape thereof substantially matches a profile of at least one of the exterior surfaces of the rotor blade.

In one embodiment, the method may further include removing air from within the outer covering after molding the support pad so as to provide the semi-solid or solid shape of the support pad that substantially matches the profile of at least one of the exterior surfaces of the rotor blade.

In another embodiment, the method may include reinjecting air into the outer covering after removing the air to return the support pad to its fluid state. In such an embodiment, the method may include remolding the support pad after reinjecting the air to reshape the support pad to a different shape that substantially matches a profile of at least one exterior surface of a different rotor blade.

In further embodiments, the method may include applying a magnetic field to the changeable fluid so as to change the changeable fluid from fluid to the semi-solid or solid shape of the support pad. It should be understood that the method may further include any of the additional steps and/or features as described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a side view of one embodiment of a rotor blade according to the present disclosure;

FIG. 3 illustrates a perspective view of one embodiment of a handling device according to the present disclosure, particularly illustrating a rotor blade positioned therein;

FIG. 4 illustrates a perspective view of the handling device of FIG. 3, with the rotor blade removed;

FIG. 5 illustrates a side view of one embodiment of the root cradle of the handling device according to the present disclosure, particularly illustrating the moldable support pad without a rotor blade configured thereon;

FIG. 6 illustrates a side view of the root cradle of FIG. 5 with the rotor blade configured thereon, particularly illustrating the moldable support pad conformed to the exterior surface of the rotor blade;

FIG. 7 illustrates a side view of one embodiment of a moldable support pad according to the present disclosure, particularly illustrating a support pad filled with a plurality of granules of equal size;

FIG. 8 illustrates a side view of another embodiment of a moldable support pad according to the present disclosure, particularly illustrating a support pad filled with a plurality of granules of varying size;

FIG. 9 illustrates a side view of still another embodiment of a moldable support pad according to the present disclosure, particularly illustrating a support pad filled with a changeable fluid;

FIG. 10 illustrates a schematic block diagram of one embodiment of a vacuum system of a handling device for a rotor blade of a wind turbine according to the present disclosure; and,

FIG. 11 illustrates a flow diagram of one embodiment of a method for handling a rotor blade during lifting or lowering of the rotor blade to and from a hub mounted atop a tower of a wind turbine according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a handling device for a wind turbine rotor blade that can be used for lifting, lowering, transporting, or storing the rotor blade. In one embodiment, the handling device includes a cradle for supporting the rotor blade and a moldable support pad secured to the cradle. More specifically, in certain embodiments, the moldable support pad includes an outer covering filled with a plurality of granules that act as a fluid when the rotor blade is placed atop the support pad such that a shape of the support pad substantially matches a profile of at least one of the exterior surfaces of the rotor blade.

The present disclosure provides many advantages not present in the prior art. For example, the handling device of the present disclosure reduces potential blade damage due to gripping-type interfaces. Rather, the present disclosure supports and secures the blade by its own weight. Further, the handling device of the present disclosure spreads the load imposed on the surface of a blade during handling and transportation thereof. In addition, since the support pad is adjustable and moldable, custom support pads are not required for varying blade shapes. As such, the present disclosure provides an economic, universal support pad that can fit essentially any blade contour.

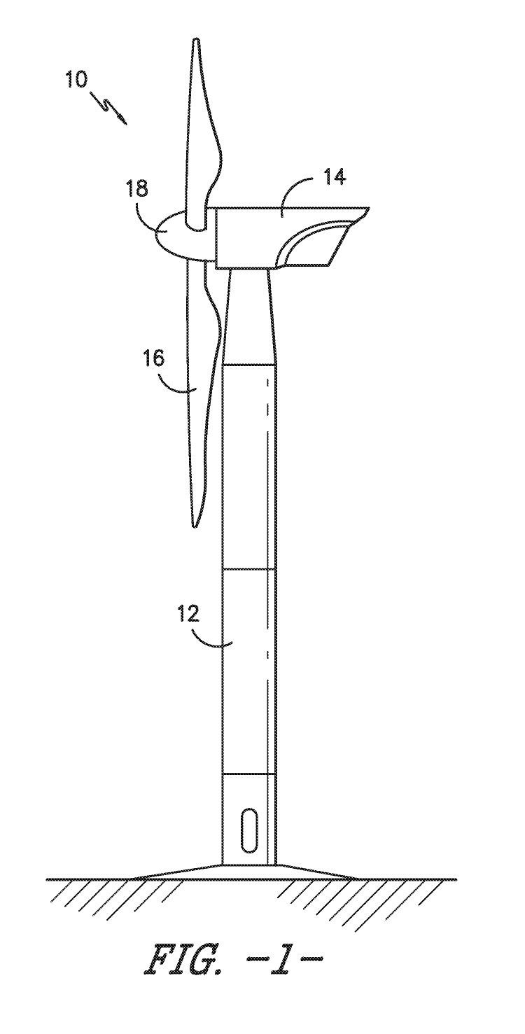

Referring now to the drawings, FIG. 1 illustrates a wind turbine 10 of conventional construction. The wind turbine 10 includes a tower 12 with a nacelle 14 mounted thereon. A plurality of rotor blades 16 are mounted to a rotor hub 18, such as via the roots (discussed below) of the rotor blades, which is in turn connected to a main flange that turns a main rotor shaft (not shown). The wind turbine power generation and control components are typically housed within the nacelle 14 and/or the tower 12. The view of FIG. 1 is provided for illustrative purposes only to place the present invention in an exemplary field of use. It should be appreciated that the invention is not limited to any particular type of wind turbine configuration.

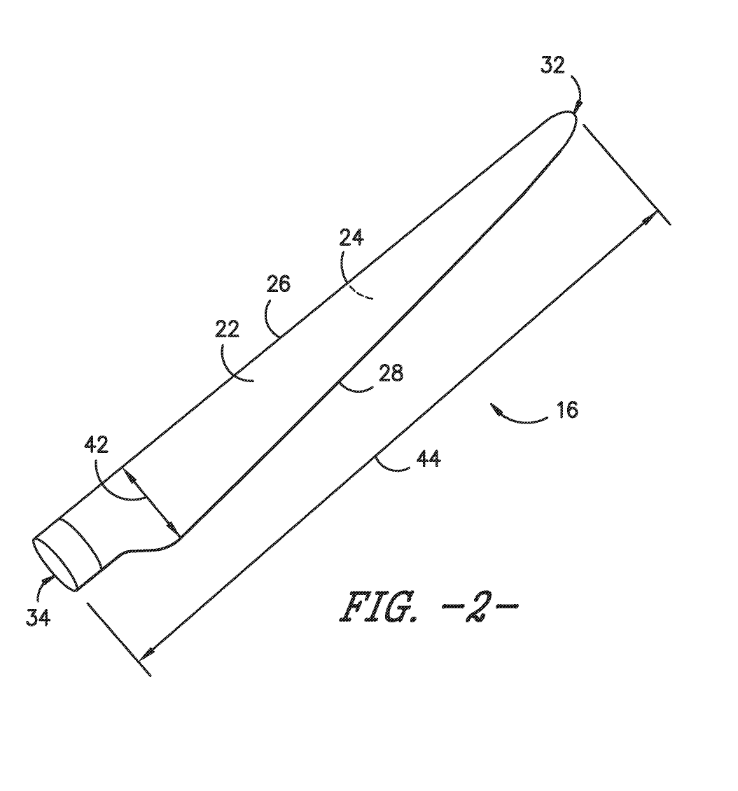

Referring to FIG. 2, a perspective view of one embodiment of a rotor blade 16 according to the present disclosure is illustrated. As shown, the rotor blade 16 includes exterior surfaces defining a pressure side 22 and a suction side 24 extending between a leading edge 26 and a trailing edge 28, and may extend from a blade tip 32 to a blade root 34. The exterior surfaces may be generally aerodynamic surfaces having generally aerodynamic contours, as is generally known in the art. In some embodiments, the rotor blade 16 may include a plurality of individual blade segments aligned in an end-to-end order from the blade tip 32 to the blade root 34. Each of the individual blade segments may be uniquely configured such that the plurality of blade segments define a complete rotor blade 16 having a designed aerodynamic profile, length, and other desired characteristics. For example, each of the blade segments may have an aerodynamic profile that corresponds to the aerodynamic profile of adjacent blade segments. Thus, the aerodynamic profiles of the blade segments may form a continuous aerodynamic profile of the rotor blade 16. Alternatively, the rotor blade 16 may be formed as a singular, unitary blade having the designed aerodynamic profile, length, and other desired characteristics.

The rotor blade 16 may, in exemplary embodiments, be curved. Curving of the rotor blade 16 may entail bending the rotor blade 16 in a generally flap-wise direction and/or in a generally edge-wise direction. The flap-wise direction may generally be construed as the direction (or the opposite direction) in which the aerodynamic lift acts on the rotor blade 16. The edge-wise direction is generally perpendicular to the flap-wise direction. Flap-wise curvature of the rotor blade 16 is also known as pre-bend, while edgewise curvature is also known as sweep. Thus, a curved rotor blade 16 may be pre-bent and/or swept. Curving may enable the rotor blade 16 to better withstand flapwise and edgewise loads during operation of the wind turbine 10, and may further provide clearance for the rotor blade 16 from the tower 12 during operation of the wind turbine 10.

Still referring to FIG. 2, the rotor blade 16 may further define chord 42 and a span 44. Further, as shown in FIG. 2, the chord 42 may vary throughout the span 44 of the rotor blade 16. Thus, a local chord may be defined for the rotor blade 16 at any point on the rotor blade 16 along the span 44. The exterior surfaces, as discussed above, may extend in the generally span-wise direction between the tip 32 and root 34.

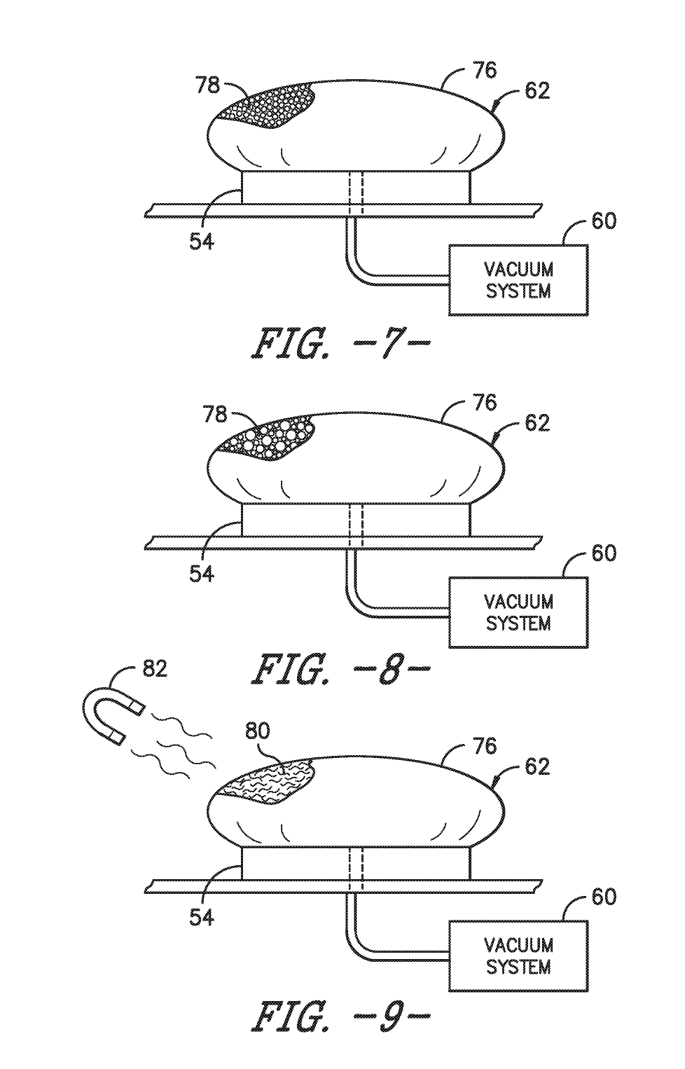

Referring now to FIGS. 3-9, various components of a handling device 52 configured to support at least a portion of the rotor blade 16 during lifting, lowering, transporting, and/or storing thereof are illustrated. More specifically, as shown, the handling device 52 includes at least one cradle 54, 56 and an optional vacuum system 60 (FIGS. 6 and 7) configured with the cradle(s) 54, 56, which is described in more detail below. For example, as shown generally in FIGS. 3-6, the handling device 52 includes a root cradle 54 and a tip cradle 56 for supporting portions of the blade 16 near the blade root 34 and the blade tip 32, respectively.

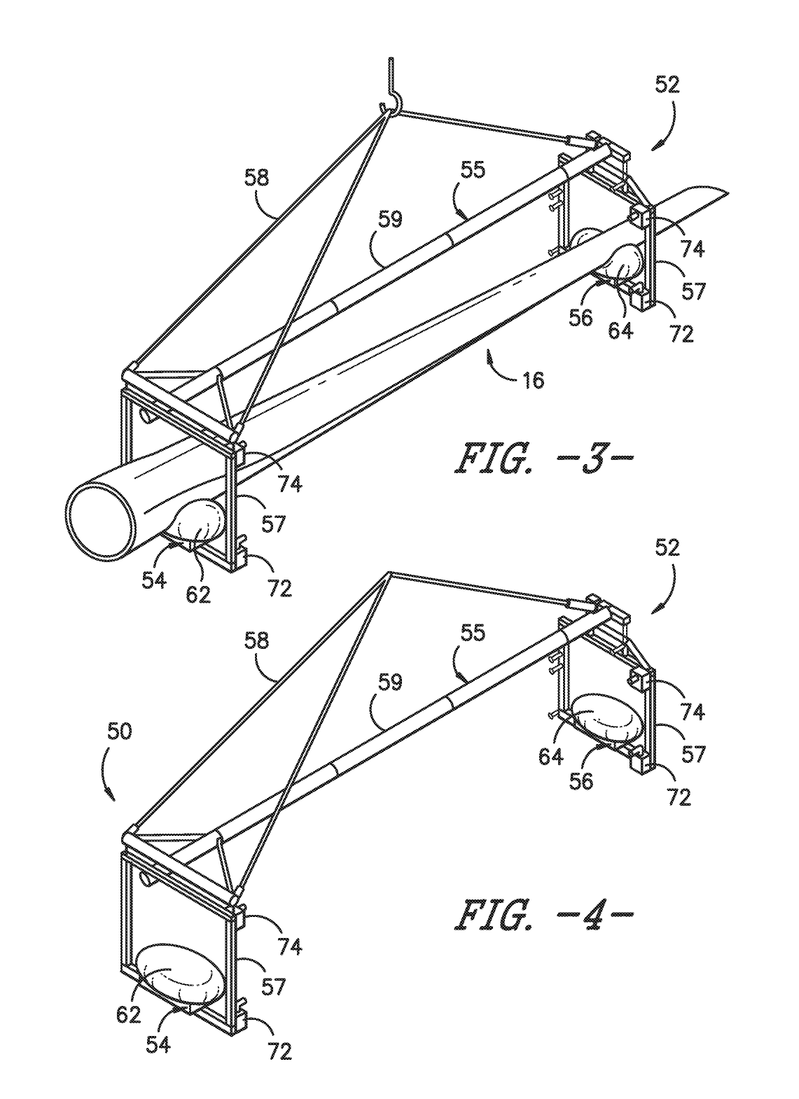

In addition, as shown in FIGS. 3-5, the handling device 52 may include a structural frame body 55 for connecting and supporting the root cradle 54 and the tip cradle 56. More specifically, as shown, the structural frame body 55 may include one or more cradle supports 57 configured to support each of the root and tip cradles 54, 56, respectively. Thus, as shown, the root and tip cradles 54, 56 may be mounted to respective ends of the structural frame body 55. Further, the cradle supports 57 may be joined or coupled together via a main support 59 or beam. Thus, in additional embodiments, the lift system 50 may also include a crane (not shown) and a crane cable or sling 58 (FIGS. 3 and 4). In such embodiments, the crane cable or sling 58 may be connected to the crane and the structural frame body 55 (i.e. at a central location along the main support 59) for lifting and/or lowering the rotor blade 16 between the hub 18 and the tower 12. More specifically, as shown, the crane cable or sling 58 may include a synthetic fabric sling and a point attachment at the center of the structural frame body 55 so as to provide stability to the handling device 52 during maneuvering thereof.

The crane as described herein may be any suitable machine for generally lifting equipment and/or materials, such as a mobile crane, a floating crane, an aerial crane, or a fixed crane (such as a tower crane), as is generally known in the art. Further, the crane cable or sling 58 may be connected to the crane, and the crane may control movement of the crane cable or sling 58, as is generally known in the art.

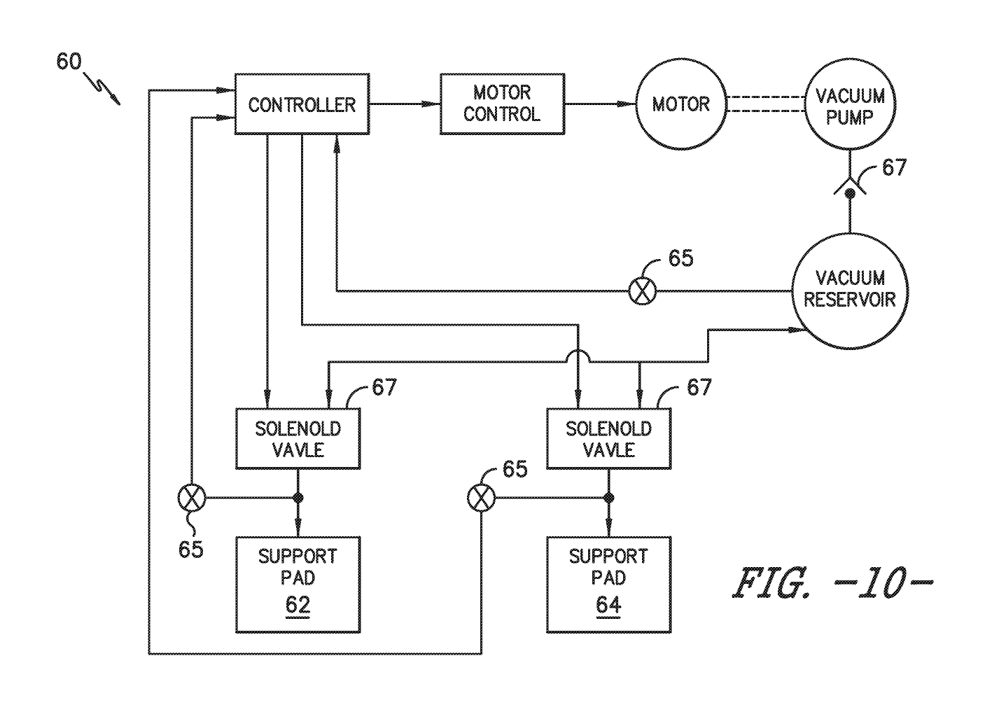

In addition, as shown in FIGS. 3-9, at least one moldable support pad 62, 64 may be secured to each of the cradles 54, 56. For example, as shown, the handling device 52 includes a first moldable support pad 62 and a second moldable support pad 64 secured to the root and tip cradles 54, 56, respectively. Thus, as shown, the support pads 62, 64 are configured to contact at least one of the exterior surfaces of the rotor blade 16 when the blade 16 is installed in the handling device 52. More specifically, as shown in the illustrated embodiment of FIGS. 7 and 8, the moldable support pad(s) 62, 64 includes an outer covering 76 filled with a plurality of granules 78 that act as a fluid when the rotor blade 16 is placed atop the support pad(s) 62, 64 such that a shape of the support pad(s) 62, 64 substantially matches a profile of at least one of the exterior surfaces of the rotor blade 16 (FIG. 6).

Further, the outer covering 76 of the support pads 62, 64 may be constructed of any suitable material. Thus, in certain embodiments, the outer covering 76 of the support pads 62, 64 may be constructed of an elastomeric material, a fabric material, or a polymer material. For example, in one embodiment, the outer covering 76 of the support pads 62, 64 may be constructed of polyurethane, rubber, cotton, silicone, latex, or any other suitable elastomeric materials or combinations thereof.

In addition, in one embodiment, the plurality of granules 78 may be made of a foam material (such as polystyrene), organic matter, a polymeric material, or any other suitable material or combinations thereof. In another embodiment, each of the plurality of granules 78 may have one or more cross-sectional shapes, including but not limited to a circle (as shown in FIG. 7), an oval, a triangle, a square, a rectangle, or similar. In several embodiments, as shown in FIG. 7, all of the granules 78 may be the same size. Alternatively, some of the granules 78 may have varying sizes. In addition, as shown in FIG. 8, each of the plurality of granules 78 may have a diameter of less than about five (5) millimeters (mm). In further embodiments, the diameter of the granules 78 may be more than or less than 5 mm.

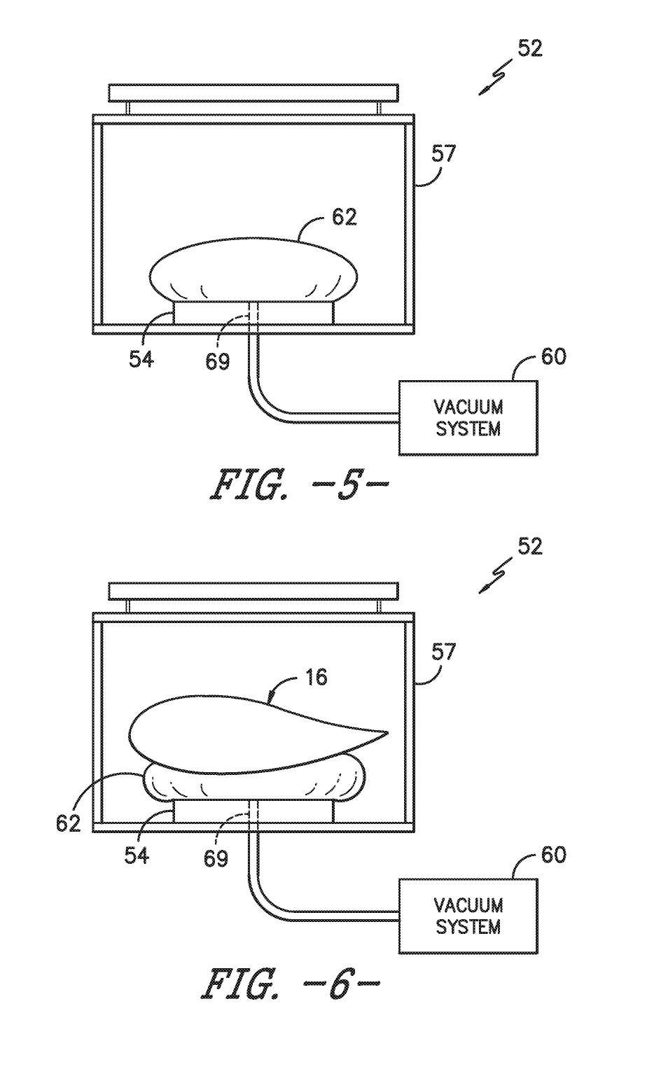

Referring now to FIGS. 5, 6, and 9, the handling device 52 may further include a vacuum system 60 configured to remove air from within the outer covering 76 of the support pad(s) 62, 64 after the rotor blade 16 is placed thereon. In such embodiments, removal of the air from within the outer covering 76 causes the moldable support pad(s) 62, 64 to transform to a semi-solid or solid state that substantially matches the profile of one of the exterior surfaces of the rotor blade 16 and also maintains its shape.

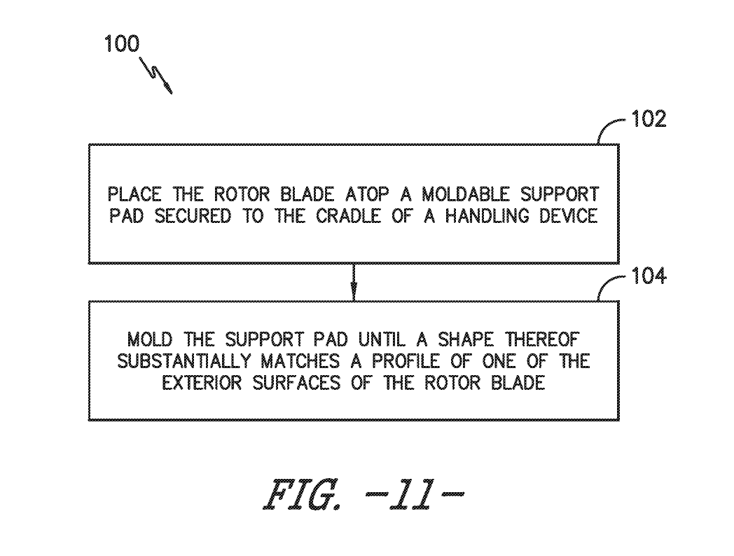

The vacuum system 60 described herein may include any suitable components for removing air from the support pad(s) 62, 64. For example, as shown in FIG. 10, the vacuum system 60 may include, at least, a controller 70 communicatively coupled to a vacuum reservoir 66, a vacuum pump 68, one or more valves 67, and one or more pressure transmitters 65 or sensors configured to transmit one or more pressure signals to the controller 70. Further, the vacuum pump 68 may include any suitable pump, e.g. having a motor 72 and/or optional motor control 74. In addition, each of the cradles 54, 56 may be equipped with one or more vacuum channels 69 in fluid communication to the vacuum reservoir 66 of the vacuum system 60.

Thus, in certain embodiments, the controller 70 is configured to receive pressure signals indicative of a vacuum pressure of the vacuum system 60 from the pressure transmitters 65. Accordingly, the controller 70 is configured to control the amount of air in the support pad(s) 62, 64 via the valve(s) 67 so as to maintain a shape thereof.

The controller 70 as described herein may be incorporated into a suitable control system of the wind turbine 10 (not shown), such as a handheld remote, a personal digital assistant, cellular telephone, a separate pendant controller, or a computer. Further, the controller 70 may include suitable processing apparatus and software for operating the vacuum system 60 as desired or required.

Referring now to FIG. 9, rather than containing a plurality of granules 78, the outer covering 76 of the moldable support pad(s) 62, 64 may be filled with a changeable fluid 80. Thus, the changeable fluid 80 is configured to change between a fluid state and a semi-solid or solid state upon applying an outside force. For example, in one embodiment, the changeable fluid 80 may include a magnetorheological fluid, which generally refers to a type of smart fluid in a carrier fluid. Further, the outside force may be a magnetic field device 82 for generating and passing a magnetic field through the magnetorheological fluid so as to change the fluid to the semi-solid or solid state. In other words, in such embodiments, when subjected to a magnetic field, the changeable fluid 80 greatly increases its apparent viscosity, to the point of becoming a viscoelastic solid.

The present disclosure is further directed to methods for handling a rotor blade during lifting or lowering of the rotor blade 16 to and from the uptower hub 18 of the wind turbine 10. For example, as shown in FIG. 11 at 102, the method 100 includes placing the rotor blade 16 atop one or more of the moldable support pads 62, 64 secured to one of the cradles 54, 56 of the handling device 52. As mentioned, in one embodiment, the moldable support pad(s) 62, 64 includes an outer covering 76 filled with at least one of a plurality of granules 78 that act as a fluid when the rotor blade 16 is placed atop the support pads 62, 64. Alternatively, as mentioned, the moldable support pad(s) 62, 64 may include a changeable fluid within the outer covering 76 that can change between a fluid state and a semi-solid or solid state upon applying an outside force. Thus, as shown at 104, the method 100 includes molding the support pads 62, 64 until a shape thereof substantially matches a profile of at least one of the exterior surfaces of the rotor blade 16.

In additional embodiments, the method 100 may also include removing air from within the outer covering 76 after molding the support pad(s) 62, 64 so as to provide the semi-solid or solid shape of the support pad(s) 62, 64 that substantially matches the profile of at least one of the exterior surfaces of the rotor blade 16. More specifically, the vacuum system 60 provided herein may be configured with the support pad(s) 62, 64 so as to remove air therefrom.

In another embodiment, to reposition the rotor blade 16 (or to position a different rotor blade), the method 100 may include reinjecting air into the outer covering 76 after removing the air to return the support pad(s) 62, 64 to its fluid state. In such an embodiment, the method 100 may include remolding the support pad(s) 62, 64 after reinjecting the air to reshape the support pad(s) 62, 64 to a different shape that substantially matches a profile of at least one exterior surface of a different rotor blade (or a different location on the same rotor blade 16).

In further embodiments, wherein the outer covering 76 is filled with the changeable fluid (e.g. such as magnetorheological fluid), the method 100 may include applying a magnetic field to the changeable fluid so as to change the changeable fluid from fluid to the semi-solid or solid shape of the support pad(s) 62, 64.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A handling device for a rotor blade of a wind turbine, the handling device comprising:
at least one cradle for supporting the rotor blade; and,
a moldable support pad secured to the cradle, the moldable support pad comprising an outer covering filled with a plurality of granules that act as a fluid when the rotor blade is placed atop the support pad such that a shape of the support pad substantially matches a profile of at least one of the exterior surfaces of the rotor blade.

2. The handling device of claim 1, wherein the plurality of granules comprise at least one of foam material, organic matter, or polymeric material.

3. The handling device of claim 1, wherein the plurality of granules comprise one or more cross-sectional shapes, the one or more cross-sectional shapes comprising at least one of a circle, an oval, a triangle, a square, or a rectangle.

4. The handling device of claim 1, wherein each of the plurality of granules comprise a diameter of less than about five millimeters (mm).

5. The handling device of claim 1, wherein the plurality of granules comprise varying sizes.

6. The handling device of claim 1, wherein the plurality of granules comprise equal sizes.

7. The handling device of claim 1, wherein the outer covering is constructed of at least one of an elastomeric material, a fabric material, or a polymer material.

8. The handling device of claim 1, further comprising a vacuum system configured to remove air from within the outer covering after the rotor blade is placed atop the support pad, wherein removal of the air from within the outer covering causes the moldable support pad to transform to a semi-solid or solid state that substantially matches the profile of at least one of the exterior surfaces of the rotor blade.

9. The handling device of claim 1, wherein the handling device is used for at least one of lifting, lowering, transporting, or storing the rotor blade.

10. The handling device of claim 1, further comprising a root cradle for supporting the root of the rotor blade, a tip cradle for supporting the tip of the rotor blade, and a structural frame body for connecting and supporting the root cradle and the tip cradle, wherein the root and tip cradles comprise a first moldable support pad and a second moldable support pad, respectively.

11. A handling device for a rotor blade of a wind turbine, the handling device comprising:
at least one cradle for supporting the rotor blade;
a moldable support pad secured to the cradle, the moldable support pad comprising an outer covering filled with a changeable fluid, the changeable fluid configured to change from a fluid state to a semi-solid or solid state upon applying an outside force once the rotor blade is placed thereon.

12. The handling device of claim 11, wherein the changeable fluid comprises a magnetorheological fluid.

13. The handling device of claim 12, wherein the outside force comprises a magnetic field device for generating and passing a magnetic field through the magnetorheological fluid so as to change the changeable fluid from the fluid state to the semi-solid or solid state.

14. The handling device of claim 11, wherein the outer covering is constructed of at least one of an elastomeric material, a fabric material, or a polymer material.

15. The handling device of claim 11, wherein the handling device is used for at least one of lifting, lowering, transporting, or storing the rotor blade.

16. A method for handling a rotor blade during lifting or lowering of the rotor blade to and from a hub mounted atop a tower of a wind turbine, the method comprising:
placing the rotor blade atop a moldable support pad secured to a cradle of a handling device, the moldable support pad comprising an outer covering filled with at least one of a plurality of granules that act as a fluid when the rotor blade is placed atop the support pad or a changeable fluid that can change between a fluid state and a semi-solid state or a solid state upon applying an outside force; and,
molding the support pad until a shape thereof substantially matches a profile of at least one of the exterior surfaces of the rotor blade.

17. The method of claim 16, further comprising removing air from within the outer covering after molding the support pad so as to provide the semi-solid or solid shape of the support pad that substantially matches the profile of at least one of the exterior surfaces of the rotor blade.

18. The method of claim 17, further comprising reinjecting air into the outer covering after removing the air to return the support pad to its fluid state.

19. The method of claim 18, further comprising remolding the support pad after reinjecting the air to reshape the support pad to a different shape that substantially matches a profile of at least one exterior surface of a different rotor blade.

20. The method of claim 16, further comprising applying a magnetic field to the changeable fluid so as to change the changeable fluid from fluid to the semi-solid or solid shape of the support pad.
